(19) United States
(12) Patent Application Publication
(10) Pub. No.: US 2026/0092214 A1
(43) Pub. Date: Apr. 2, 2026

(54) POLYMERIZABLE COMPOUND AND USE THEREOF

(71) Applicant: BEIJING BAYI SPACE LCD TECHNOLOGY CO., LTD., Beijing (CN)

(72) Inventors: Xianfeng XU, Beijing (CN); Wenlong GUO, Beijing (CN); Yijie TANG, Beijing (CN); Qingtong DI, Beijing (CN); Hao ZHANG, Beijing (CN); Kun BIAN, Beijing (CN); Qiaoyun MA, Beijing (CN); Xinqing LIU, Beijing (CN)

(21) Appl. No.: 19/410,710

(22) Filed: Dec. 5, 2025

Related U.S. Application Data
(63) Continuation of application No. PCT/CN2024/099107, filed on Jun. 14, 2024.

(30) Foreign Application Priority Data
Jun. 21, 2023 (CN) 202310742977.X

(51) Int. Cl. C09K 19/04; G02F 1/137

(52) U.S. Cl. CPC C09K 19/0403; G02F 1/13775; C09K 2019/0414

(57) ABSTRACT

The present disclosure belongs to the technical field of liquid crystal materials, and particularly relates to a polymerizable compound and the use thereof. The polymerizable compound of the present disclosure has a structure as shown in general formula I. Compared with the prior art, the polymerizable compound of the present disclosure has good solubility, a better alignment effect, a higher polymerization rate, more complete polymerization, and lower residue, thereby greatly improving the problem of poor display; a liquid crystal composition containing the polymerizable compound has a better alignment effect, more complete polymerization, and lower residue; and the polymerizable compound has a low price and stable performance, can be widely applied to the field of liquid crystal display, and has an important application value.

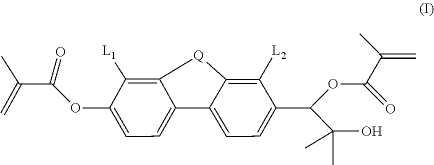

### CROSS-REFERENCES

This application claims priority to Chinese Patent Application No. 202310742977.X, filed on Jun. 21, 2023 and entitled “POLYMERIZABLE COMPOUND AND USE THEREOF”, the entire disclosure of which is incorporated herein by reference in its entirety.

### TECHNICAL FIELD

The present disclosure belongs to the technical field of liquid crystal materials, and particularly relates to a polymerizable compound and the use thereof.

### BACKGROUND ART

In recent years, liquid crystal display devices are widely used in various electronic devices, such as a smart phone, a tablet computer, an automotive navigator, and a television. Representative liquid crystal display modes include twisted nematic (TN) type, super twisted nematic (STN) type, in-plane switching (IPS) type, fringe-field switching (FFS) type and vertical alignment (VA) type. Among them, the VA mode has received more and more attention due to its fast falling time, high contrast ratio, wide viewing angle and high-quality images.

However, the liquid crystal medium used in a display element of the active matrix addressing type such as the VA mode has its own shortcomings, for example, the residual image level is significantly worse than that of a display element with positive dielectric anisotropy, the response time is relatively slow, and the driving voltage is relatively high. In order to solve the problems described above, several new types of VA display technologies have emerged, such as MVA, PVA, and PSVA. The PSVA technology achieves a wide-viewing-angle display mode similar to MVA/PVA while simplifying the CF process, resulting in reduced CF cost, a higher aperture ratio, increased brightness, and, in turn, a higher contrast ratio. Furthermore, due to the presence of a pretilt angle across the entire liquid crystal layer, there is no domino delay effect, allowing for a faster response time at the same driving voltage with no adverse effect on the residual image level.

The prior art has found that LC mixtures and RMs still exhibit some drawbacks when applied to PSA displays. First, not every desired soluble RM has so far been found to be suitable for PSA displays; moreover, if polymerization is desired via UV light without the addition of a photoinitiator (which may be advantageous for certain applications), the range of choices becomes even smaller; additionally, the “material system” formed by combining the LC mixture (hereinafter also referred to as “LC host mixture”) with a selected polymerizable component should have minimal rotational viscosity and optimal photoelectric properties, so as to increase the “voltage holding ratio” (VHR) to achieve the desired effect. For PSVA, achieving a high VHR after (UV) light irradiation is very important; otherwise, it will lead to problems such as image sticking in the final display. To date, due to issues such as the polymerizable units being sensitive only to excessively short UV wavelengths, the absence or insufficiency of tilt angle formation after light exposure, or the poor uniformity of the polymerizable component after light exposure, not all combinations composed of the LC mixture and polymerizable components are suitable for PSVA displays.

Therefore, the synthesis of novel polymerizable compounds with superior performance and the investigation of their structure-property relationships have become an imperative task in the field of liquid crystals.

### SUMMARY OF THE INVENTION

A first object of the present disclosure is to provide a polymerizable compound for polymer stabilization technology. The liquid crystal composition containing the compound exhibits a better alignment effect, more complete polymerization, and lower residues. Furthermore, the compound has a low price and stable performance, can be widely applied to the field of liquid crystal display, and has an important application value.

The liquid crystal compound of the present disclosure has a structure as follows:

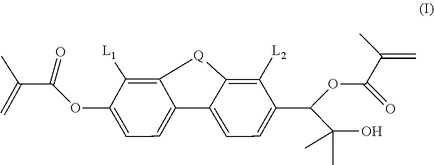

where L₁ and L₂ are the same or different and represent, independently of each other, H, —F, —Cl, —CN, —CH₃, —C₂H₅, —OCH₃, —OC₂H₅, —CF₃, —OCF₃, —OCHF₂, or —OC₂F₅; and Q represents —CH₂—, —CF₂—, —C(CH₃)—, —CH₂CH₂—, —CH₂O—, —CH₂S—, or —CHFCHF—.

Further, L₁ and L₂ are the same or different and represent, independently of each other, H, —F, —Cl, —CN, —CH₃, —OCH₃, —CF₃, —OCF₃, or —OCHF₂.

Further, L₁ and L₂ are the same or different and represent, independently of each other, H, —F, or —Cl.

As a still further preferred technical solution of the present disclosure, the compound is selected from one of the following compounds:

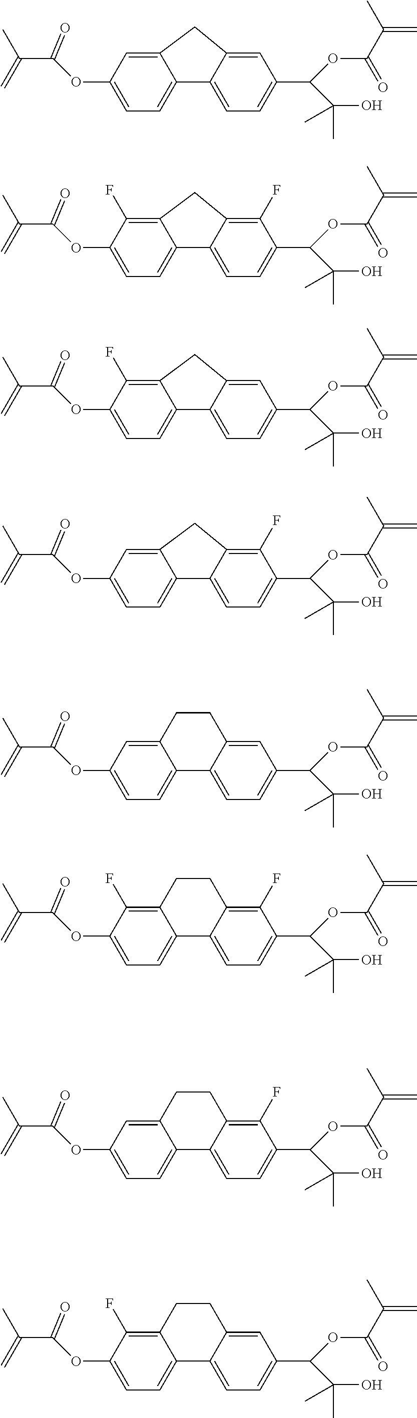

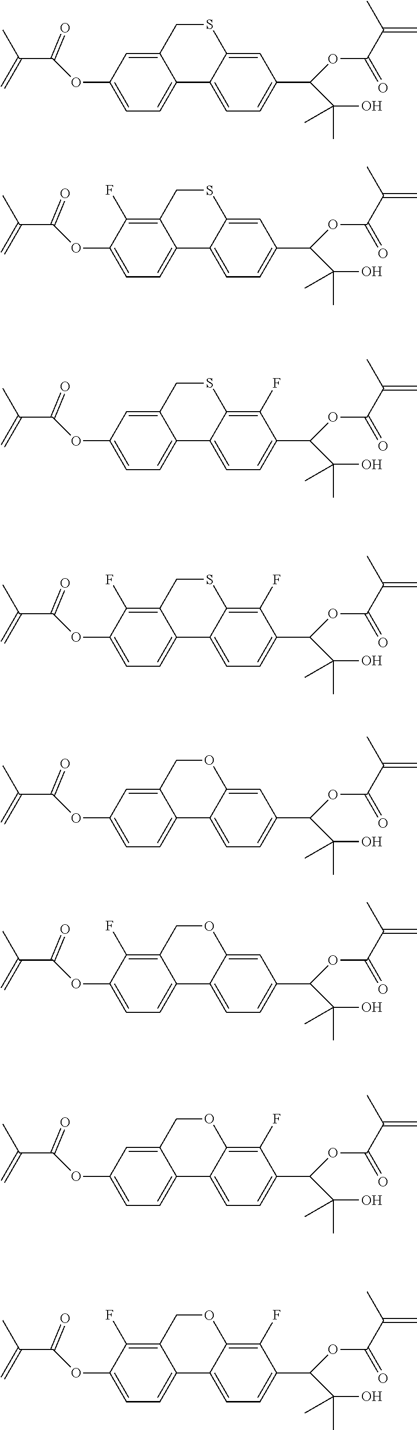

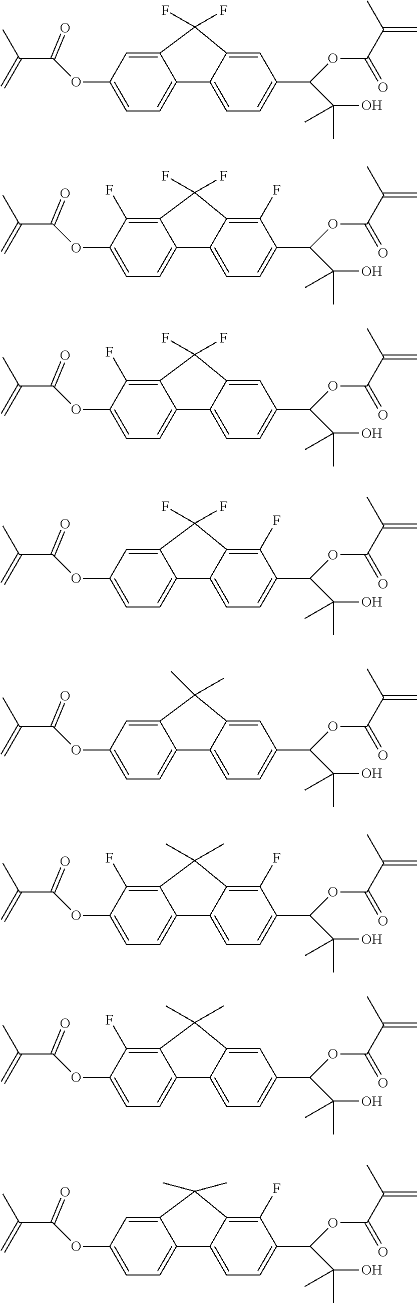

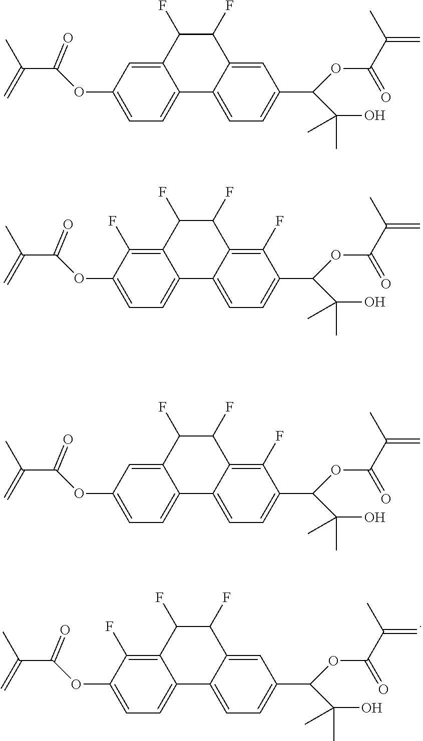

A second object of the present disclosure is to set forth a liquid crystal composition comprising the polymerizable compound. The mass percentage of the polymerizable compound in the liquid crystal composition is 0.01-10%, preferably 0.01-5%, further preferably 0.1-3%.

A third object of the present disclosure is to set forth the use of the polymerizable compound and the liquid crystal composition containing the polymerizable compound in the field of liquid crystal display, and preferably in a liquid crystal display device. The liquid crystal display device includes, but is not limited to, a TN, ADS, VA, PSVA, FFS, or IPS liquid crystal display.

### DETAILED DESCRIPTION OF EMBODIMENTS

The following examples are intended to illustrate the present disclosure, but not to limit the scope of the present disclosure, and other equivalent alternations or modifications made without departing from the spirit disclosed in the present disclosure shall fall within the scope of the claims.

Unless otherwise specified, the liquid crystal compounds used in the following examples can be synthesized by well-known methods or obtained from public commercial sources. These synthesis techniques are conventional, and the obtained liquid crystal compounds meet the standards of electronic compounds after test.

According to the conventional detection methods in the art, the performance parameters of the liquid crystal compounds are obtained by linear fitting, wherein the specific meanings of the performance parameters are as follows:

Δn represents the optical anisotropy (25° C.); Δε represents the dielectric anisotropy (25° C., 1000 Hz); γ1 represents the rotational viscosity (mPa·s, 25° C.); and Cp represents the clearing point.

### Example 1

The polymerizable compound had a structural formula of:

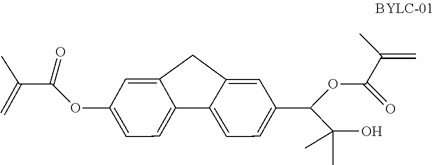 [SMILES: C=C(C)C(=O)Oc1ccc2c(c1)Cc1cc(C(OC(=O)C(=C)C)C(C)(C)O)ccc1-2]

The synthetic route to prepare compound BYLC-01 was shown below:

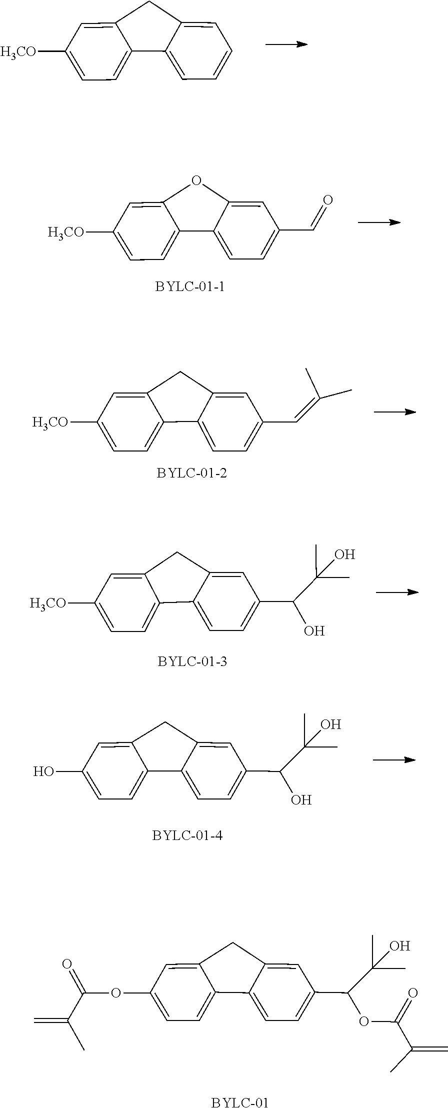

The specific steps were as follows:

### (1) Synthesis of Compound BYLC-01-1:

39.2 g (0.2 mol) of 2-methoxyfluorene and 29.37 g (0.22 mol) of aluminum trichloride were added to 100 ml of carbon disulfide, and cooled to 0° C.; 35.1 g (0.3 mol) of 1,1-dichloromethyl ether was slowly added dropwise, during which the temperature was controlled at 0-10° C.; and after the dropwise addition was completed, the system was heated to 50° C. and allowed to react for 6 hours with the temperature being controlled at 45-55° C. The reaction solution was cooled to 0-10° C. in an ice water bath, and 80 g of water was added dropwise thereto and stirred for 1 hour, followed by liquid separation; and the aqueous phase was extracted once with dichloromethane, and the organic phases were combined, dried over anhydrous magnesium sulfate, filtered and concentrated to obtain crude 7-methoxyfluorene-2-carboxaldehyde, followed by column chromatography to obtain 40.7 g of the pure product (BYLC-01-1, 0.18 mol), GC: 99.0%, yield: 90%.

### (2) Synthesis of Compound BYLC-01-2:

Under the protection of nitrogen, 116.1 g (0.27 mol) of isopropyltriphenylphosphonium iodide and 300 ml of tetrahydrofuran were added to a 1000 ml reaction flask; the system was cooled to 10° C., and 30.2 g (0.24 mol) of potassium tert-butoxide was added and stirred for 1 hour, and a solution of 40.7 g (0.18 ml) of 7-methoxyfluorene-2-carboxaldehyde and 200 ml of tetrahydrofuran was then added with the temperature controlled at a maximum of 10° C.; after stirring for 1 hour, the system was neutralized with 2 M hydrochloric acid, and the mixture was extracted three times with n-heptane; the organic phases were combined, dried over anhydrous sodium sulfate, and filtered to remove triphenylphosphine oxide; and the solvent was evaporated to dryness, and the system was recrystallized with 5-fold volume of ethanol to obtain 36 g of a white solid (compound BYLC-01-2, 0.144 mol), GC: 99.7%, yield: 80%.

### (3) Synthesis of Compound BYLC-01-3

36 g (0.144 mol) of BYLC-01-2 and 27.4 g of 4-methylmorpholine-4-oxide were added to a 500 ml three-necked flask at room temperature, followed by 700 ml of acetone and 50 ml of distilled water; 18 ml of a 4% aqueous osmium tetroxide solution was added dropwise and stirred at room temperature for 48 hours; then 250 ml of water was added, and the mixture was neutralized with 2 M hydrochloric acid, followed by liquid separation; the aqueous phase was extracted with ethyl acetate, and the organic phases were combined and dried; and the solvent was evaporated to dryness, followed by crystallization with ethyl acetate to obtain the product BYLC-01-3, 36.8 g (0.13 mol), GC: 99.5%, yield: 90%.

### (4) Synthesis of Compound BYLC-01-4

36.8 g of BYLC-01-3 and 500 ml of dichloromethane were added to a 1000 ml three-necked flask, the system was cooled to 0° C., 42.2 g of boron tribromide diethyl etherate was added dropwise, and after the addition was completed, the mixture was stirred at 0° C. for 2 hours; and 100 ml of water was slowly added dropwise, and the mixture was stirred for 0.5 hours, followed by liquid separation, washing with water, drying, and recrystallization with acetonitrile to obtain BYLC-01-4, 31.6 g (0.117 mol), GC: 99.5%, yield: 90%.

### (5) Synthesis of Compound BYLC-01

Under the protection of nitrogen, 31.6 g (0.117 mol) of compound BYLC-01-4, 60 g of triethylamine, 10 g of 4-dimethylaminopyridine, and 500 ml of dichloromethane were added to a 1000 ml reaction flask; and with the temperature being controlled at −10° C. to −15° C., 27 g of methacryloyl chloride was added dropwise, and the system was allowed to react for 1 h with the temperature maintained at −10° C. to −15° C., and then react at room temperature for 6 hours. The reaction solution was poured into water and neutralized with sodium bicarbonate until neutral. Following conventional post-treatments, the resulting product was recrystallized with petroleum ether to obtain 40.9 g of a white solid (compound BYLC-01, 0.1 mol), GC: 99.9%, yield: 86%.

The resulting white solid BYLC-01 was analyzed by means of GC-MS, and the m/z of the product was 406.1 (M+).

1H-NMR (300 MHz, CDCl₃): 1.24-2.01 (s, 12H), 3.65-5.31 (s, 4H), 6.18-6.43 (m, 4H), 7.25-8.25 (m, 6H).

### Example 2

The polymerizable compound had a structural formula of:

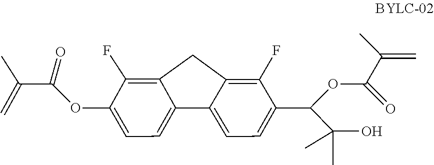 [SMILES: C=C(C)C(=O)Oc1ccc2c(c1F)Cc1c-2ccc(C(OC(=O)C(=C)C)C(C)(C)O)c1F]

Following the method in Example 1, BYLC-02 was synthesized.

The resulting white solid BYLC-02 was analyzed by means of GC-MS, and the m/z of the product was 442.1 (M+).

1H-NMR (300 MHz, CDCl₃): 1.24-2.01 (s, 12H), 3.65-5.31 (s, 4H), 6.18-6.43 (m, 4H), 7.25-8.25 (m, 4H).

### Example 3

The polymerizable compound had a structural formula of:

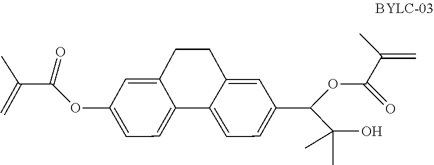 [SMILES: C=C(C)C(=O)Oc1ccc2c(c1)CCc1cc(C(OC(=O)C(=C)C)C(C)(C)O)ccc1-2]

Following the method in Example 1, BYLC-03 was synthesized.

The resulting white solid BYLC-03 was analyzed by means of GC-MS, and the m/z of the product was 420.2 (M+).

1H-NMR (300 MHz, CDCl₃): 1.24-2.01 (s, 12H), 2.99-5.31 (s, 6H), 6.18-6.43 (m, 4H), 7.25-8.25 (m, 6H).

### Example 4

The polymerizable compound had a structural formula of:

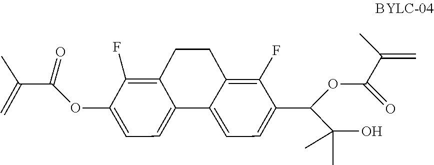 [SMILES: C=C(C)C(=O)Oc1ccc2c(c1F)CCc1c-2ccc(C(OC(=O)C(=C)C)C(C)(C)O)c1F]

Following the method in Example 1, BYLC-04 was synthesized.

The resulting white solid BYLC-04 was analyzed by means of GC-MS, and the m/z of the product was 456.1 (M+).

1H-NMR (300 MHz, CDCl₃): 1.24-2.01 (s, 12H), 2.99-5.31 (s, 6H), 6.18-6.43 (m, 4H), 7.25-8.25 (m, 4H).

### Example 5

The polymerizable compound had a structural formula of:

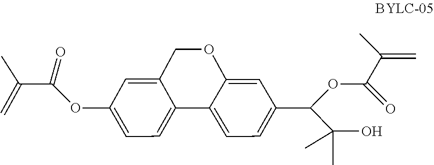 [SMILES: C=C(C)C(=O)Oc1ccc2c(c1)COc1cc(C(OC(=O)C(=C)C)C(C)(C)O)ccc1-2]

Following the method in Example 1, BYLC-05 was synthesized.

The resulting white solid BYLC-05 was analyzed by means of GC-MS, and the m/z of the product was 422.1 (M+).

1H-NMR (300 MHz, CDCl₃): 1.24-2.01 (s, 12H), 3.65-5.31 (s, 4H), 6.18-6.43 (m, 4H), 7.25-8.25 (m, 6H).

### Example 6

The polymerizable compound had a structural formula of:

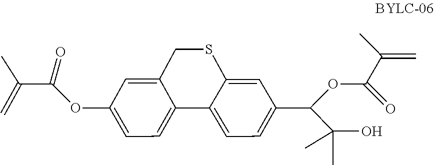 [SMILES: C=C(C)C(=O)Oc1ccc2c(c1)CSc1cc(C(OC(=O)C(=C)C)C(C)(C)O)ccc1-2]

Following the method in Example 1, BYLC-06 was synthesized.

The resulting white solid BYLC-05 was analyzed by means of GC-MS, and the m/z of the product was 438.1 (M+).

1H-NMR (300 MHz, CDCl₃): 1.24-2.01 (s, 12H), 3.65-5.31 (s, 4H), 6.18-6.43 (m, 4H), 7.25-8.25 (m, 6H).

### Example 7

The polymerizable compound had a structural formula of:

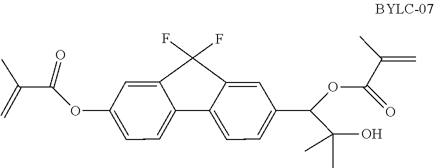 [SMILES: C=C(C)C(=O)Oc1ccc2c(c1)C(F)(F)c1cc(C(OC(=O)C(=C)C)C(C)(C)O)ccc1-2]

Following the method in Example 1, BYLC-07 was synthesized.

The resulting white solid BYLC-07 was analyzed by means of GC-MS, and the m/z of the product was 442.1 (M+).

1H-NMR (300 MHz, CDCl₃): 1.24-2.01 (s, 12H), 3.65-5.31 (s, 2H), 6.18-6.43 (m, 4H), 7.19-7.84 (m, 6H).

### Example 8

The polymerizable compound had a structural formula of:

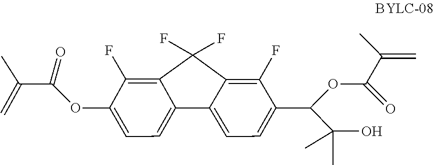 [SMILES: C=C(C)C(=O)Oc1ccc2c(c1F)C(F)(F)c1c-2ccc(C(OC(=O)C(=C)C)C(C)(C)O)c1F]

Following the method in Example 1, BYLC-08 was synthesized.

The resulting white solid BYLC-08 was analyzed by means of GC-MS, and the m/z of the product was 478.1 (M+).

1H-NMR (300 MHz, CDCl₃): 1.24-2.01 (s, 12H), 3.65-5.31 (s, 2H), 6.18-6.43 (m, 4H), 7.19-7.84 (m, 4H).

### Example 9

The polymerizable compound had a structural formula of:

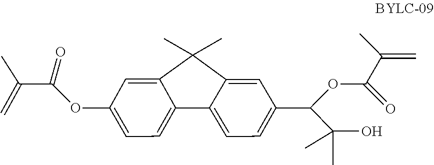 [SMILES: C=C(C)C(=O)Oc1ccc2c(c1)C(C)(C)c1cc(C(OC(=O)C(=C)C)C(C)(C)O)ccc1-2]

Following the method in Example 1, BYLC-09 was synthesized.

The resulting white solid BYLC-09 was analyzed by means of GC-MS, and the m/z of the product was 434.5 (M+).

1H-NMR (300 MHz, CDCl₃): 1.24-2.01 (s, 18H), 3.65-5.31 (s, 2H), 6.18-6.43 (m, 4H), 7.25-8.25 (m, 6H).

### Example 10

The polymerizable compound had a structural formula of:

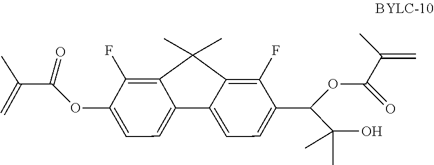 [SMILES: C=C(C)C(=O)Oc1ccc2c(c1F)C(C)(C)c1c-2ccc(C(OC(=O)C(=C)C)C(C)(C)O)c1F]

Following the method in Example 1, BYLC-10 was synthesized.

The resulting white solid BYLC-10 was analyzed by means of GC-MS, and the m/z of the product was 470.1 (M+).

1H-NMR (300 MHz, CDCl₃): 1.24-2.01 (s, 18H), 3.65-5.31 (s, 2H), 6.18-6.43 (m, 4H), 7.25-8.25 (m, 4H).

### Example 11

The polymerizable compound had a structural formula of:

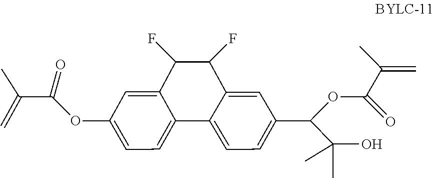 [SMILES: C=C(C)C(=O)Oc1ccc2c(c1)C(F)C(F)c1cc(C(OC(=O)C(=C)C)C(C)(C)O)ccc1-2]

Following the method in Example 1, BYLC-11 was synthesized.

The resulting white solid BYLC-11 was analyzed by means of GC-MS, and the m/z of the product was 456.1 (M+).

1H-NMR (300 MHz, CDCl₃): 1.24-2.01 (s, 12H), 3.65-5.31 (s, 2H) 5.26 (m, 2H), 6.18-6.43 (m, 4H), 7.25-8.25 (m, 6H).

### Example 12

The polymerizable compound had a structural formula of:

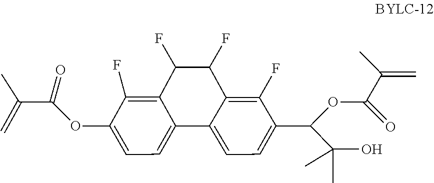 [SMILES: C=C(C)C(=O)Oc1ccc2c(c1F)C(F)C(F)c1c-2ccc(C(OC(=O)C(=C)C)C(C)(C)O)c1F]

Following the method in Example 1, BYLC-12 was synthesized.

The resulting white solid BYLC-12 was analyzed by means of GC-MS, and the m/z of the product was 492.1 (M+)

1H-NMR (300 MHz, CDCl₃): 1.24-2.01 (s, 12H), 3.65-5.31 (s, 2H) 5.26 (m, 2H), 6.18-6.43 (m, 4H), 7.25-8.25 (m, 4H).

### Test Example 1

The properties of mixed crystal BHR87800 are listed in Table 1:

TABLE 1
Summary of properties of mixed crystal BHR87800

| Properties | Cp | Δn | Δε | ε_{\|} | K₃/K₁ |
|---|---|---|---|---|---|
| Numerical | +70° C. | 0.095 | −3.5 | 3.3 | 0.97 |
| value | | | | | |

The mixture BHR87800 was purchased from Bayi Space LCD Technology Co., Ltd. 0.3% of polymerizable compounds BYLC-01 to BYLC-12 provided in Examples 1-12 were added to 99.7% of a liquid crystal composition BHR87800, respectively, and dissolved until uniform to obtain mixtures PM-1 to PM-12. The physical properties of PM-1 to PM-12 were almost the same as those of the mixture BHR87800 described above.

PM-1 to PM-12 were injected into a test cassette with a gap of 4.0 μm and vertical alignment using a vacuum infusion process. One side of the test cassette was applied with square waves having a frequency of 60 HZ and a driving voltage of 24 V, and the other side was irradiated with ultraviolet by using a high pressure mercury UV lamp, where the irradiation intensity on the surface of the cassette was adjusted to 100 mW/cm² and the irradiation lasted for 600 s, so as to obtain a polymerized vertically aligned liquid crystal display element. The pretilt angle was measured using an LCT-5016E liquid crystal photoelectric parameter tester. The test cassette was then decomposed, and the residual polymerizable compound in the liquid crystal composition was determined by high performance liquid chromatography (HPLC). The results are summarized in Tables 2 and 3.

### Comparative Example

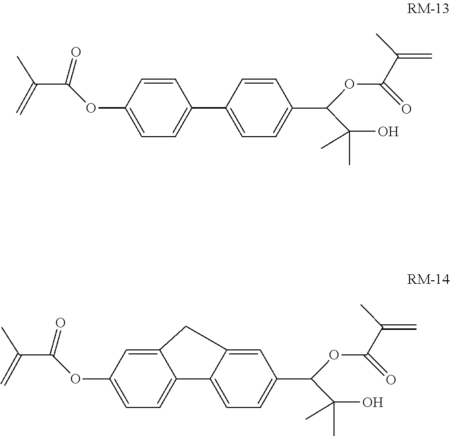

0.3% of polymerizable compounds RM-13 and RM-14 were added to 99.7% of mixture BHR87800, respectively, and dissolved until uniform to obtain mixtures PM-13 and PM-14. The physical properties of PM-13 and PM-14 were almost the same as those of the mixture BHR87800 described above. PM-13 and PM-14 were injected into a test cassette with a gap of 4.0 μm and vertical alignment using a vacuum infusion process. One side of the test cassette was applied with square waves having a frequency of 60 HZ and a driving voltage of 24 V, and the other side was irradiated with ultraviolet by using a high pressure mercury UV lamp, where the irradiation intensity on the surface of the cassette was adjusted to 100 mW/cm² and the irradiation lasted for 600 s, so as to obtain a polymerized vertically aligned liquid crystal display element. The pretilt angle was measured using an LCT-5016E liquid crystal photoelectric parameter tester. The test cassette was then decomposed, and the residual polymerizable compound in the liquid crystal composition was determined by high performance liquid chromatography (HPLC). The results are summarized in Tables 2 and 3.

TABLE 2
Summary of pretilt angle before and after UV irradiation

| | Before UV | After UV irradiation |
|---|---|---|
| | irradiation (°) | (360 s) (°) |
| PM-1 | 89.7 | 75.1 |
| PM-3 | 89.8 | 76.3 |
| PM-5 | 89.7 | 74.1 |
| PM-7 | 89.7 | 75.3 |
| PM-9 | 89.7 | 76.2 |
| PM-11 | 89.7 | 77.1 |
| PM-13 | 89.6 | 77.5 |
| PM-14 | 89.6 | 77.8 |

TABLE 3
Summary of polymer residue data

| UV | PM-1 | PM-3 | PM-5 | PM-7 | PM-9 | PM-11 | PM-13 | PM-14 |
|---|---|---|---|---|---|---|---|---|
| polymer- | polymer | polymer | polymer | polymer | polymer | polymer | polymer | polymer |
| ization | residue | residue | residue | residue | residue | residue | residue | residue |
| time (s) | (%) | (%) | (%) | (%) | (%) | (%) | (%) | (%) |
| 0 | 0.3 | 0.3 | 0.3 | 0.3 | 0.3 | 0.3 | 0.3 | 0.3 |
| 120 | 0.24 | 0.25 | 0.23 | 0.22 | 0.24 | 0.23 | 0.26 | 0.25 |
| 240 | 0.18 | 0.20 | 0.19 | 0.19 | 0.19 | 0.20 | 0.23 | 0.22 |
| 360 | 0.15 | 0.16 | 0.16 | 0.16 | 0.16 | 0.16 | 0.20 | 0.19 |
| 480 | 0.13 | 0.14 | 0.13 | 0.14 | 0.13 | 0.13 | 0.18 | 0.17 |
| 600 | 0.11 | 0.12 | 0.10 | 0.11 | 0.10 | 0.12 | 0.16 | 0.15 |

As can be seen from the comparative data in Tables 2 and 3, the polymerizable compound of the present disclosure exhibits a better alignment effect, a higher polymerization rate, more complete polymerization, and lower residues than the polymerizable liquid crystal compounds RM-13 and RM-14, thereby significantly improving the problem of poor display.

Although the present disclosure has been described in detail with general explanations, specific embodiments and tests, it is obvious to a person skilled in the art that some modifications or improvements can be made thereto based on the present disclosure. Therefore, all the modifications and improvements which can be made without departing from the spirit of the present disclosure belong to the scope of protection of the present disclosure.

### INDUSTRIAL APPLICABILITY

Compared with the prior art, the polymerizable compound of the present disclosure has good solubility, a better alignment effect, a higher polymerization rate, more complete polymerization, and lower residues, thereby greatly improving the problem of poor display; a liquid crystal composition containing the polymerizable compound has a better alignment effect, more complete polymerization, and lower residue; and the polymerizable compound has a low price and stable performance, can be widely applied to the field of liquid crystal display, and has an important application value.

1. A polymerizable compound, having a structure as shown in general formula I: 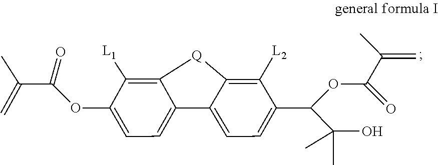
wherein L₁ and L₂ are the same or different and represent, independently of each other, H, —F, —Cl, —CN, —CH₃, —C₂H₅, —OCH₃, —OC₂H₅, —CF₃, —OCF₃, —OCHF₂, or —OC₂F₅; and
Q represents —CH₂—, —CF₂—, —C(CH₃)₂—, —CH₂CH₂—, —CH₂O—, —CH₂S—, or —CHFCHF—.

2. The polymerizable compound according to claim 1, wherein L₁ and L₂ are the same or different and represent, independently of each other, H, —F, —Cl, —CN, —CH₃, —OCH₃, —CF₃, —OCF₃, or —OCHF₂.

3. The polymerizable compound according to claim 2, wherein L₁ and L₂ are the same or different and represent, independently of each other, H, —F, or —Cl.

4. The polymerizable compound according to claim 1, wherein the polymerizable compound is selected from one of the following compounds:

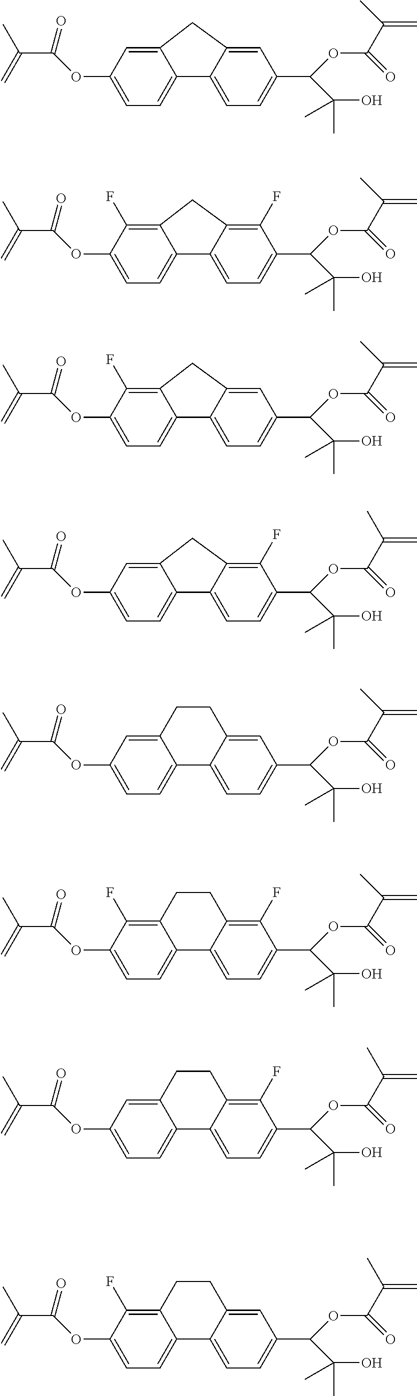

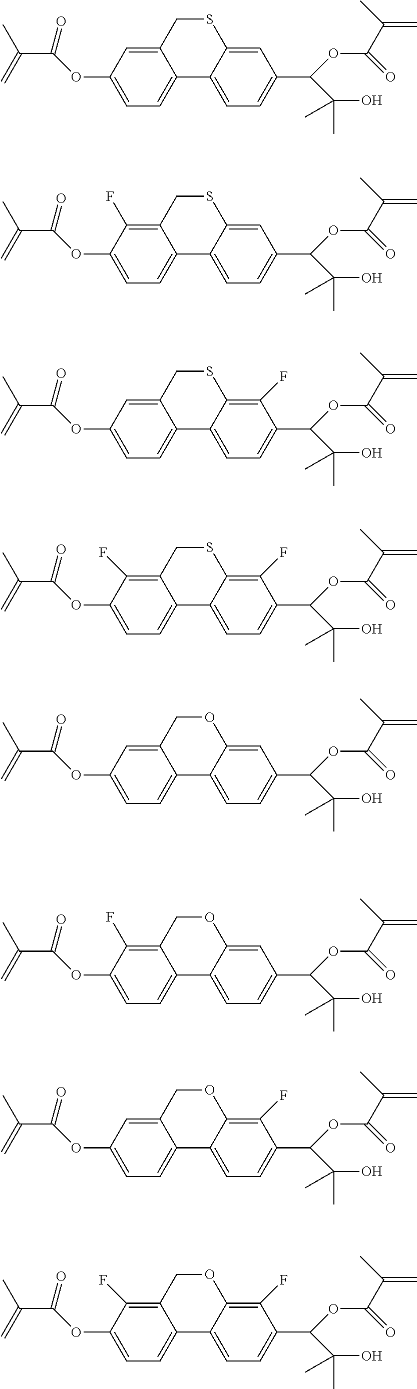

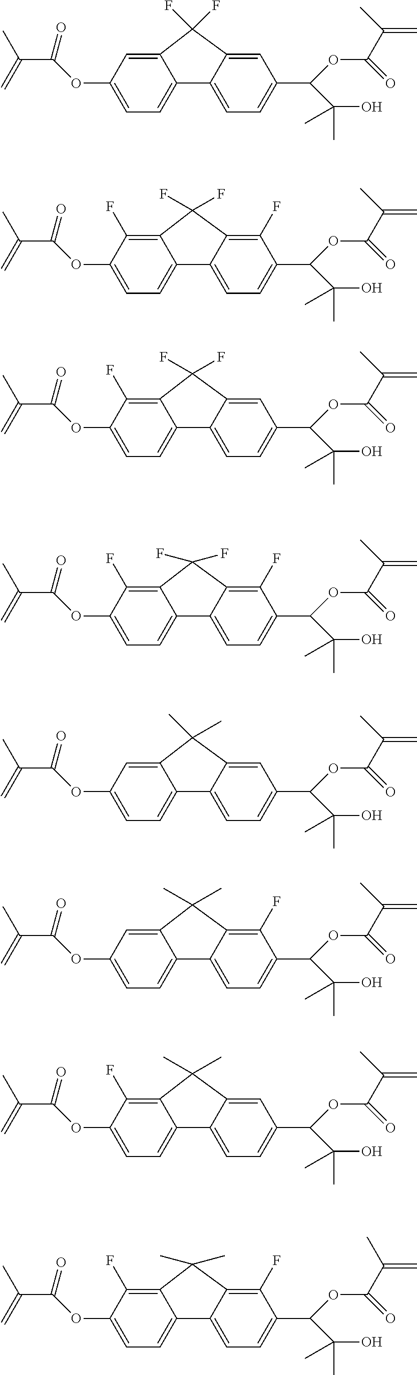

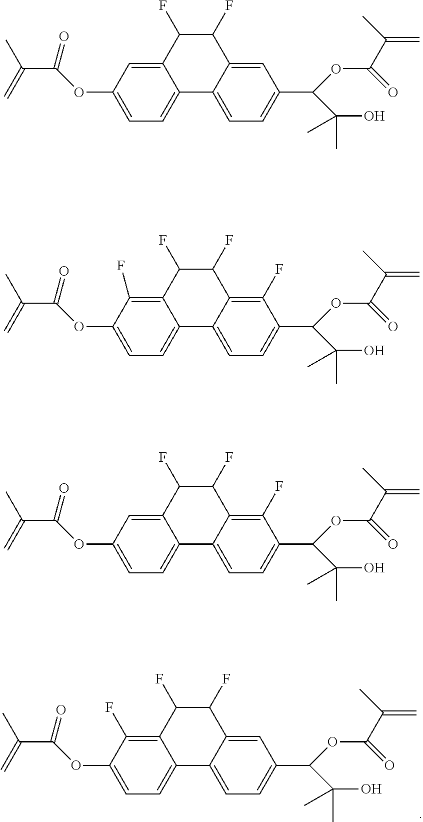

5. A liquid crystal composition, comprising the polymerizable compound according to claim 1.

6. The liquid crystal composition according to claim 5, wherein the mass percentage of the polymerizable compound in the liquid crystal composition is 0.01-10%.

7. The liquid crystal composition according to claim 6, wherein the mass percentage of the polymerizable compound in the liquid crystal composition is 0.01-5%.

8. The liquid crystal composition according to claim 7, wherein the mass percentage of the polymerizable compound in the liquid crystal composition is 0.1-3%.

9. The use of the polymerizable compound according to claim 1 in the field of liquid crystal display, preferably in a liquid crystal display device.

10. The use according to claim 9, wherein the liquid crystal display device comprises a TN, ADS, VA, PSVA, FFS, or IPS liquid crystal display.

11. The liquid crystal composition according to claim 5 in the field of liquid crystal display, preferably in a liquid crystal display device.
